(19) United States
(12) Patent Application Publication
(10) Pub. No.: US 2025/0220562 A1
(43) Pub. Date: Jul. 3, 2025

(54) Augmented Wireless Environment Reporting

(71) Applicant: Cisco Technology, Inc., San Jose, CA (US)

(72) Inventors: Robert Barton, VANCOUVER (CA); Jerome Henry, Pittsboro, NC (US); Vinay Saini, Bangalore (IN); Vishal S. Desai, San Jose, CA (US)

(21) Appl. No.: 18/917,963

(22) Filed: Oct. 16, 2024

(30) Foreign Application Priority Data
Dec. 28, 2023 (IN) 202341089516

(51) Int. Cl. H04W 48/16; H04W 84/18

(52) U.S. Cl. CPC H04W 48/16; H04W 84/18

(57) ABSTRACT

Devices and methods for augmenting wireless environment reporting are provided. The information provided by 802.11k reports may have limited functionality, as they do not offer extended details that could be beneficial to the network infrastructure. Augmented wireless environment reporting allows network devices and client devices to request for Wireless Environment Reports (WERs) based on several augmented parameters. A device, such as a network device or a client device, generates a WER request including at least one of a condition, a Peer-to-Peer (P2P) technology specification, a non-IEEE 802.11 technology specification, or an element restriction and transmits the WER request to another device such as a client station. The other devices generates the WER with augmented information as requested and transmits to the device. The information included in the WER report may be processed and utilized to perform network analytics, network management tasks, and other functions useful to the network infrastructure.

The present disclosure relates to communication networks. More particularly, the present disclosure relates to augmented wireless environment reporting for optimizing wireless network management.

This application claims the benefit of Indian Provisional Patent Application No. 202341089516, filed Dec. 28, 2023, which is incorporated by reference herein in its entirety.

### BACKGROUND

The Institute of Electrical and Electronics Engineers (IEEE) 802.11k standard enhances the ability of wireless networks, particularly Wireless Local Area Networks (WLANs), to manage seamless transitions between access points for client devices. Client devices may roam from one access point to another when they experience a weak signal. The roaming decision may be based on various factors including, for example, received signal strength and availability of access points on the same network or other networks that the client device previously joined, or which are configured for auto-join. The 802.11k standard may assist client devices to quickly identify neighboring access points that are available for roaming and to roam faster between the access points, ensuring a smoother handoff and minimizing packet loss during transitions. This is particularly beneficial for applications like Voice over Internet Protocol (VoIP), where performance is sensitive to roaming delays.

Client devices that support the IEEE 802.11k standard, also referred to as “11k-capable client devices”, may request their current access point for a neighbor report including information about known neighboring access points that are candidates for roaming. The neighbor report may include a list of neighboring access points, also referred to as a “neighbor list”. The 802.11k neighbor report improves the roaming experience for client devices by enabling the client devices to make more informed decisions about when and where to roam, which helps in optimizing network performance and ensuring a smoother handoff between access points.

The 802.11k standard may also allow an access point to request information from one of its client devices, for example, in the form of an 802.11k beacon report, requesting the client device to scan (actively or passively) one or more channels or bands, and report on the access points detected in those channels or bands. The access point can also request the client device to merely share a result from a previous scan or a recent scan. The client device can be requested to report on all detected access points associated with any Service Set Identifier (SSID), or only on a single SSID with which the client device is associated. The 802.11k beacon report may primarily provide a view of the wireless environment from the perspective of the client device. However, as 802.11k reports were designed for roaming decisions only, the limited information they provide may assist the station or client device in only finding the next best access point, without providing extended information that is useful to a network infrastructure and that may help the station or client device in multiple other dimensions.

### SUMMARY OF THE DISCLOSURE

Devices and methods for augmenting wireless environment reporting to optimize wireless network management in accordance with embodiments of the disclosure are described herein.

In many embodiments, a network device comprises a processor, a network interface controller configured to provide access to a network, and a memory communicatively coupled to the processor. The memory comprises a network management logic that is configured to generate a wireless environment report request, transmit the generated wireless environment report request, and receive a wireless environment report based on the transmitted wireless environment report request. The wireless environment report request comprises at least one of a condition, a Peer-to-Peer (P2P) technology specification, a non-IEEE 802.11 technology specification, or an element restriction.

In a variety of embodiments, the wireless environment report request comprises the condition.

In a number of embodiments, the wireless environment report request is configured to indicate an excluded service set identifier (SSID).

In further embodiments, the wireless environment report request is configured to indicate an SSID and the condition associated with the SSID.

In more embodiments, the wireless environment report request is configured to indicate at least one of a channel or a band.

In yet more embodiments, the wireless environment report request is further configured to indicate reporting of a local SSID on the indicated at least one of the channel or the band.

In still more embodiments, the wireless environment report request is further configured to indicate reporting of an absence of a neighbor SSID on the indicated at least one of the channel or the band.

In still yet more embodiments, the wireless environment report request is further configured to indicate reporting of all local SSIDs on the indicated at least one of the channel or the band based on a local SSID being detected on the indicated at least one of the channel or the band.

In various embodiments, the wireless environment report request is further configured to indicate reporting of all local SSIDs on the indicated at least one of the channel or the band based on a local SSID being undetected on the indicated at least one of the channel or the band.

In several embodiments, the wireless environment report request is further configured to indicate reporting of a result of a criteria-based evaluation.

In numerous embodiments, the criteria-based evaluation comprises one or more logical operations.

In additional embodiments, the wireless environment report request comprises the P2P technology specification.

In several additional embodiments, the wireless environment report request is configured to indicate reporting of a number of P2P pairs.

In numerous additional embodiments, the wireless environment report request comprises the non-IEEE 802.11 technology specification.

In still additional embodiments, the wireless environment report request is configured to indicate at least one of a channel or a band.

In yet additional embodiments, the wireless environment report request comprises the element restriction.

In still yet additional embodiments, the wireless environment report request is transmitted to a client device, and the wireless environment report is received from the client device.

In further additional embodiments, a client device comprises a processor, network interface controller configured to provide access to a network, and a memory communicatively coupled to the processor. The memory comprises a network management logic that is configured to generate a wireless environment report and transmit the wireless environment report. The wireless environment report is associated with at least one of a condition, a P2P technology specification, a non-IEEE 802.11 technology specification, or an element restriction.

In many further embodiments, the network management logic is further configured to receive a wireless environment report request. The wireless environment report request comprises the at least one of the condition, the P2P technology specification, the non-IEEE 802.11 technology specification, or the element restriction. The wireless environment report is generated based on the received wireless environment report request.

In yet various embodiments, a client devices comprises a processor, a network interface controller configured to provide access to a network, and a memory communicatively coupled to the processor. The memory comprises a network management logic that is configured to generate a wireless environment report request, transmit the generated wireless environment report request to another client device via a P2P link, and receive a wireless environment report based on the transmitted wireless environment report request from the another client device via the P2P link.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic diagram of a wireless local networking system in accordance with various embodiments of the disclosure;

FIG. 2 is a conceptual network diagram of various environments in which a network management logic may operate on a plurality of network devices in accordance with various embodiments of the disclosure;

FIG. 3 is a schematic block diagram of a wireless environment showing augmented wireless environment reporting for optimizing wireless network management in accordance with various embodiments of the disclosure;

FIG. 4 is a flowchart depicting a process for augmented wireless environment reporting from the perspective of an access point in accordance with various embodiments of the disclosure;

FIG. 5 is a flowchart depicting a process for augmented wireless environment reporting from the perspective of a station in accordance with various embodiments of the disclosure;

FIG. 6 is a flowchart depicting a process for augmented wireless environment reporting based on detection of a local Service Set Identifier (SSID) from the perspective of a station in accordance with various embodiments of the disclosure;

FIG. 7 is a flowchart depicting a process for augmented wireless environment reporting between peer client devices in accordance with various embodiments of the disclosure; and

FIG. 8 is a conceptual block diagram for a device capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, devices and methods are discussed herein for augmenting wireless environment reporting to optimize wireless network management. Wireless environment reporting may refer to rendering reports about a wireless environment including stations (herein referred to as “STAs”), access points, client devices, or the like. These reports may provide extended information that is useful to a network infrastructure and that may help in network analytics, in addition to facilitating intelligent roaming decisions. The reports may include, for example, 802.11k neighbor reports, 802.11k beacon reports, and other conditional reports. The information included in these reports may be processed and utilized to perform network analytics, network management tasks, and other functions useful to the network infrastructure.

The Institute of Electrical and Electronics Engineers (IEEE) 802.11k standard may allow STAs including client devices to request information from their access points about neighboring access points (typically on the same Extended Service Set “ESS”), in the form of 802.11k neighbor reports to assist in making intelligent roaming decisions. When a client device requests a report using the 802.11k standard, for example, an 802.11k neighbor report, from an access point, the access point may may transmit information including, for example, a Basic Service Set Identifier (BSSID) of the access point, a Service Set Identifier (SSID), channel information, maximum (max)/minimum (min) information, or the like, to the client device. The 802.11k neighbor report may be configured to assist client devices in making informed roaming decisions by providing information about neighboring access points within the same or different Basic Service Sets (BSSs), that are detectable by a client device. The information provided in the 802.11k neighbor report may include for example, BSSIDs of the neighboring access points, signal strength, channel information, and other network characteristics. The 802.11k neighbor report may be utilized by client devices to determine an optimal access point to which to connect based on network conditions.

The 802.11k standard may also allow an access point to request information from one of its client devices, for example, in the form of an 802.11k beacon report, requesting the client device to scan (actively or passively) one or more channels or bands, and report on the access points detected in those channels or bands. The access point can also request the client device to merely share a result from a previous scan or a recent scan. The client device can be requested to report on all detected access points associated with any SSID, or only on a single SSID with which the client device is associated. The 802.11k beacon report may provide information specifically about beacon frames transmitted by neighboring access points. The 802.11k beacon report may provide information on the capabilities and characteristics of the neighboring access points by analyzing the beacon frames they broadcast. In addition to information about beacon frames transmitted by neighboring access points, the 802.11k beacon report may include access point capabilities, supported data rates, other configuration information broadcasted in the beacon frames, channel information, signal strength, etc.

As the above discussed 802.11k reports may be designed for roaming decisions only where the limited information they provide may assist the station or client device in only finding the next best access point, there is a need for augmented 802.11k reports including extended information that may be useful to a network infrastructure and that may help the station or client device in multiple other dimensions. In many embodiments, the devices and methods discussed herein implement an augmented mechanism for STAs to provide extended 802.11k reports to the network infrastructure to assist with wireless network management and to improve the experience of the STAs in a wireless network, for example, a Wireless Local Area Network (WLAN). In a number of embodiments, the devices and methods discussed herein provide a Radio Frequency (RF) view of a STA, which can help extend an access point view to the ground, and provide information that may be useful to the network infrastructure to help the STA in multiple other dimensions including, for example, P2P detection, detection of unusable channels, detection of Very Low Power (VLP) systems, and detection of other local RF events that may degrade the STA experience but are not directly visible to the access point. The RF view may enhance the visibility and management of wireless coverage and performance by integrating or extending data and insights from access points to a more detailed or specific level, often at a physical or operational level on the ground. In more embodiments, the devices and methods discussed herein may augment the IEEE 802.11k standard with the ability to specialize the 802.11k reports shared with the network infrastructure to assist with various network management tasks. Further, in additional embodiments, the devices and methods discussed herein may augment an 802.11k beacon report for analytics purposes. The 802.11k beacon report may be utilized for a more detailed analysis of the capabilities and configuration of the neighboring access points, which can be useful for network management and optimization.

In further embodiments, the devices and methods discussed herein may allow an access point to generate a wireless environment report request, for example, a request for a conditional beacon report, a request for a conditional neighbor report, or the like. In still more embodiments, the generated wireless environment report request may include at least one of a condition, a P2P technology specification, a non-IEEE 802.11 technology specification, or an element restriction. In still further embodiments, the wireless environment report request may include a negative SSID or an excluded SSID that may be specifically excluded from a list of available networks or from a network scan. In still additional embodiments, the wireless environment report request may include an SSID and a condition associated with the SSID. Further, the wireless environment report request may be configured to indicate at least one of a channel or a band. In yet more embodiments, when the wireless environment report request includes the condition, the wireless environment report request may be configured to indicate reporting of a local SSID on the indicated channel or the band, reporting of an absence of a neighbor SSID on the indicated channel or the band, reporting of all local SSIDs on the indicated channel or the band, and/or a result of a criteria-based evaluation. The criteria-based evaluation may include one or more logical operations. In still more embodiments, when the wireless environment report request includes the P2P technology specification, the wireless environment report request may be configured to indicate reporting of a number of P2P pairs. In still yet more embodiments, the wireless environment report request may include one or more threshold values.

In many further embodiments, the access point may transmit the generated wireless environment report request to a STA, for example, a client device. The client device may generate a wireless environment report based on the wireless environment report request. For example, the client device may generate the wireless environment report associated with at least one of the condition, the P2P technology specification, the non-IEEE 802.11 technology specification, or the element restriction, included in the wireless environment report request. The client device may transmit the generated wireless environment report to the access point. The access point may receive the generated wireless environment report.

In many additional embodiments, the wireless environment report request may be useful for RRM. RRM may involve optimizing the use of RF resources to improve network performance and efficiency and assisting in allocating radio channels to different devices or access points to minimize interference and maximize the use of the available spectrum. RRM may further involve adjusting the transmission power of devices to balance coverage and minimize interference. For example, RRM may ensure that devices utilize just enough power to communicate effectively without causing excessive interference to others. RRM may further include managing the distribution of network traffic across different access points or channels to avoid overloading any single component and to ensure a balanced and efficient network and transferring a connection of a client device from one access point to another as the client device moves, ensuring seamless connectivity. RRM may be utilized for planning and optimizing a network layout, including the placement of access points and the configuration of their settings, to enhance overall network coverage and performance. In still yet further embodiments, the wireless environment report request may be further useful for detecting rogues or neighboring access points that may disrupt managed operations of the access points, and thus affect roaming efficiency of the STA. Rogues may refer to rogue devices or unauthorized access points that attempt to connect to or interfere with a network, potentially compromising security and performance of the network. Enumerated below are example scenarios for augmenting wireless environment reporting to optimize wireless network management.

In a first example scenario, an access point or a wireless local area network controller (WLC) connected to the access point may be aware of a neighboring system that utilizes a form of Adaptive Radio Management (ARM)/RRM. ARM may refer to a subset of RRM and focus on optimizing the performance of wireless networks by dynamically adjusting radio parameters based on real-time conditions. ARM may dynamically select and allocate radio channels to minimize interference and maximize throughput, adapting to changes in the radio environment and network load. ARM may continuously analyze network performance and adapt radio parameters to improve coverage, capacity, and overall user experience. In this example scenario, the access point may request the STA, through the wireless environment report request, to scan a channel or a band and report whether a local SSID is detected and whether a neighbor SSID is not reported. The STA may generate a wireless environment report in response to the wireless environment report request from the access point. The generated wireless environment report may be utilized to direct roaming STAs to channels unaffected by the neighboring system.

In a second example scenario, an access point may request a STA, through the wireless environment report request, to scan a channel or a band, and report all SSIDs detected, but only on channels where the local SSID was also detected. The STA may generate the wireless environment report based on the wireless environment report request from the access point. The generated wireless environment report can be utilized to detect rogues that may be at the edge of other BSSs.

In a third example scenario, an access point may request a STA, through the wireless environment report request, to scan a channel or a band, and report systems detected on any channel where the local SSID is not detected. The STA may generate the wireless environment report based on the wireless environment report request from the access point. The generated wireless environment report can be utilized for RRM to predict the most efficient channel change, for example, in a scenario where directional antennas prevent neighboring access points from detecting each other.

In a fourth example scenario, an access point may request a STA, through the wireless environment report request, to perform a logical operation based on its 802.11k report and return a result. For example, the access point may request the STA to report the number of access points the STA sees on an SSID “blizzard” that have a Received Signal Strength Indicator (RSSI) greater than a first threshold value or have a Signal-to-Noise Ratio (SNR) less than a second threshold value. RSSI may refer to a measurement of the received signal strength or the power present in a received radio signal in a wireless environment.

In still yet additional embodiments, the devices and methods discussed herein may further allow an access point to generate a specialized wireless environment report request, for example, a specialized neighbor report request. The specialized neighbor report request may include an Information Element (IE) configured to indicate a type of detection requested from a STA. The IE may include elements such as a Datagram Transport Layer Security (DTLS) pair or a P2P system. In several embodiments, the P2P system may include another STA with which the STA communicates through a P2P protocol, for example, a Neighbor Awareness Networking (NAN) protocol, a DTLS protocol, or the like. The STA may generate a specialized wireless environment report, for example, a specialized neighbor report based on the specialized neighbor report request from the access point. The generated specialized neighbor report can be utilized by the access point to schedule time for the P2P exchange, detect the P2P density in a cell (and thus its effect on the BSS available airtime), or notify RRM for channel allocation. In yet several embodiments, the IE may also extend a multiband operation (MBO), other radio technology report, request a STA to scan a channel or a band, and report on active non-Wi-Fi radio that the STA utilizes or detects. The other radio technology report may refer to a report associated with a non-IEEE 802.11 technology specification. The MBO, other radio technology report may be utilized to detect, for example, the active use of Ultrawide Band (UWB) or a Bluetooth Low Energy (BLE) radio by the STA.

In further cases, an access point may have a fairly accurate view of the wireless environment, but may be missing a few elements. These elements may include, for example, information about rogue access points on a different ESS, or other information of which the access point is unsure. In this case, the access point may not need a full 802.11k report, but may only require certain fields of the 802.11k report. Thus, in an action frame transmitted to the STA, in a several additional embodiments, the access point may request the STA for only portions of the 802.11k report which are necessary, or for details about a certain access point that the STA cannot see clearly. In this case, the STA may only respond with elements or fields requested by the access point. For example, the access point may request the STA to report whether a detected access point is a VLP system, thus facilitating the detection of ad-hoc or low power systems.

In various embodiments, a client device (herein referred to as a “requesting client device”) can also generate a wireless environment report request including at least one of a condition, a P2P technology specification, a non-IEEE 802.11 technology specification, or an element restriction. The requesting client device may transmit the generated wireless environment report request to another client device (herein referred to as a “responding client device”) via a P2P link. The responding client device may generate the wireless environment report based on the wireless environment report request. For example, the responding client device may generate the wireless environment report associated with at least one of the condition, the P2P technology specification, the non-IEEE 802.11 technology specification, or the element restriction, included in the wireless environment report request. The responding client device may transmit the generated wireless environment report to the requesting client device via the P2P link. The requesting client device may receive the transmitted wireless environment report from the responding client device via the P2P link.

In yet various embodiments, the devices and methods discussed herein may allow an access point to request conditional reports from the STAs as the STAs have enough processing power. The conditional reports may include conditions, for example, “report non-blizzard SSIDs on this channel if blizzard is also detected”, “report P2P pairs on this channel”, or the like. In addition to roaming optimizations, in several more embodiments, the devices and methods discussed herein may execute exchanges between the STA and the access point that include analytics.

In numerous embodiments, the devices and methods discussed herein provide a network management logic that is configured to augment wireless environment reporting to optimize wireless network management. The network management logic can include various hardware and/or software deployments and can be configured in a variety of ways. For example, the network management logic can be configured as a standalone device, exist as a logic in another network device, be distributed among various network devices operating in tandem, or remotely operated as part of a cloud-based network management tool. Examples of the network devices that can implement the network management logic may include, but are not limited to, access points, WLCs, client devices, servers, or any other 802.11K enabled device.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a Printed Circuit Board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a PCB or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

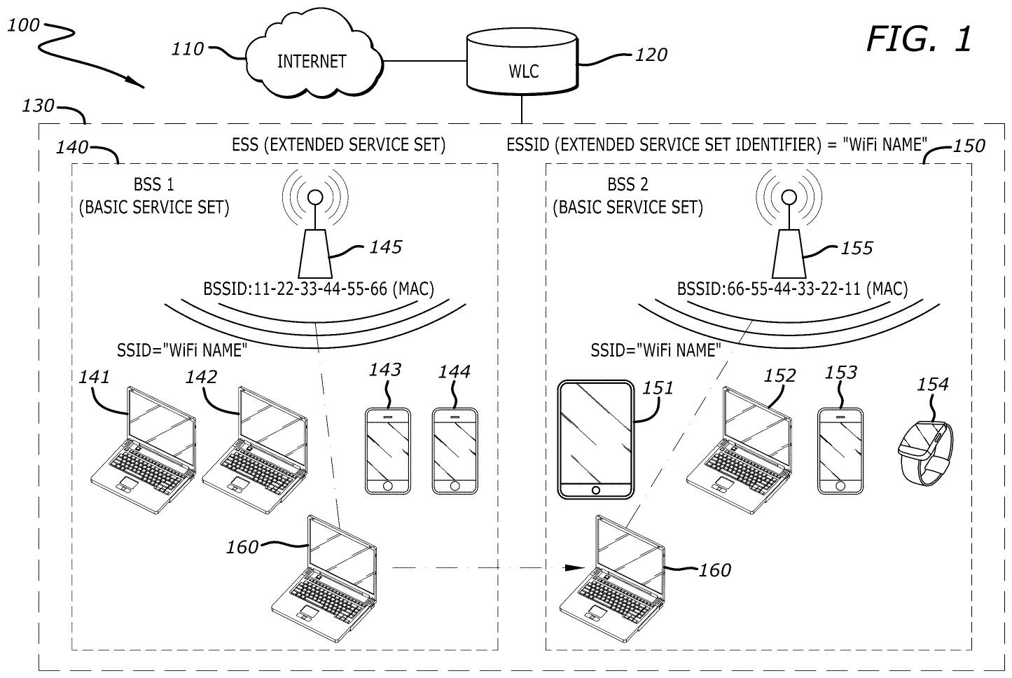

Referring to FIG. 1, a schematic diagram of a wireless local networking system 100 in accordance with various embodiments of the disclosure is shown. Wireless local networking standards allow seamless communication and connectivity between various devices within localized areas. One of these wireless local networking standards may be Wi-Fi® of the Wi-Fi Alliance Corporation, which is based on the IEEE 802.11 family of protocols. The IEEE 802.11 family of protocols are developed by the Institute of Electrical and Electronics Engineers (IEEE) that defines protocols for Wireless Local Area Networks (WLANs). Wi-Fi® provides a high-speed wireless access to the internet and local network resources, with standards such as 802.11a, 802.11b, 802.11g, 802.11n, 802.11ac, and 802.11ax, each offering improvements in speed, range, and efficiency. Each adoption of Wi-Fi® standards is often designed to generate enhanced performance, increased capacity, and better efficiency in crowded network environments. Other standards can commonly be utilized for short-range wireless communication between devices, particularly in the realm of Personal Area Networks (PANs). Both Wi-Fi® and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi® technology, a service set plays a role in defining and organizing wireless network devices. A service set may refer to a collection of wireless devices that share a common Service Set Identifier (SSID). The SSID, often recognizable to users as a network name presented in a natural language, serves as a means of identification and differentiation among various wireless networks. Within a service set, nodes comprising devices, for example, laptops, smartphones, or other Wi-Fi-enabled devices operate collaboratively, adhering to shared link-layer networking parameters. These link-layer networking parameters encompass specific communication settings and protocols that facilitate seamless interaction among the devices within the service set. The service set may form a cohesive and logical network segment, creating an organized structure for wireless communication where the devices can communicate and share data within defined parameters, enhancing the efficiency and coordination of wireless networking operations.

In the context of wireless local area networking standards, a service can be configured in two distinct forms: a Basic Service Set (BSS) or an Extended Service Set (ESS). A basic service set represents a subset within a service set, including devices that share common physical-layer medium access characteristics. These characteristics include parameters such as radio frequency, modulation scheme, and security settings, ensuring seamless wireless networking among the devices. The basic service set is uniquely identified by a Basic Service Set Identifier (BSSID), a 48-bit label adhering to MAC-48 conventions. Despite the possibility of a device having multiple BSSIDs, each BSSID is typically associated with, at most, one basic service set at any given time.

A BSS should not be confused with a coverage area of an access point, which is referred to as a Basic Service Area (BSA). The BSA encompasses a physical space within which an access point provides wireless coverage, while the basic service set focuses on the logical grouping of devices sharing common networking characteristics. The distinction emphasizes that the basic service set is a conceptual grouping based on shared communication parameters, while the basic service area defines a spatial extent of a wireless reach of an access point. Understanding these distinctions is fundamental for effectively configuring and managing wireless networks, ensuring optimal performance and coordination among connected devices.

The SSID defines a service set or an extended service set. The SSID is typically broadcast in the clear by stations in beacon packets to announce the presence of a network and is seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to transmit a list of supported SSIDs to the station. Once a device has associated with a basic service set, for efficiency, the SSID is not sent within packet headers; only BSSIDs are utilized for addressing.

An ESS is a more sophisticated wireless network architecture designed to provide seamless coverage across a larger area, typically spanning environments such as homes or offices that may be too expansive for reliable coverage by a single access point. This network is created through a collaboration of multiple access points, presenting itself to users as a unified and continuous network experience. The extended service set operates by integrating one or more infrastructure basic service sets within a common logical network segment, characterized by sharing the same Internet Protocol (IP) subnet and Virtual Local Area Network (VLAN).

The concept of an extended service set is particularly utilized in scenarios where a single access point cannot adequately cover the entire desired area. By employing multiple access points strategically, users can move seamlessly across the extended service set without experiencing disruptions in connectivity, thereby maintaining a consistent wireless experience in larger spaces, where the users may transition between different physical locations covered by distinct access points.

Moreover, extended service sets offer additional functionalities such as distribution services and centralized authentication. The distribution services facilitate an efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

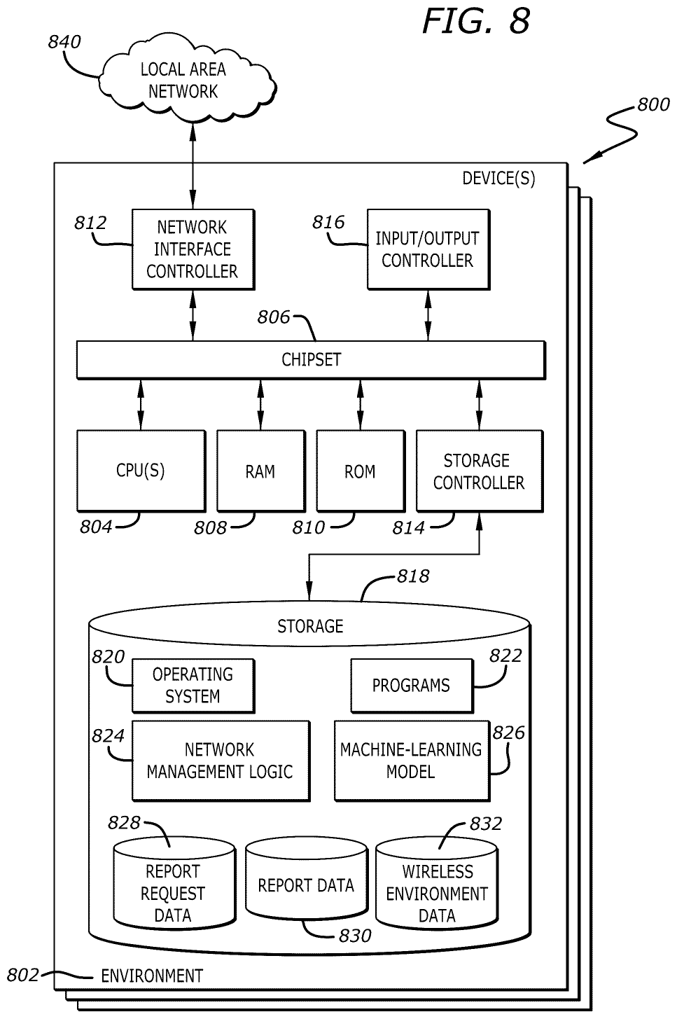

The network can include a variety of user end devices that connect to the network. These devices can sometimes be referred to as stations (STAs). Each device is typically configured with a medium access control (MAC) address in accordance with the IEEE 802.11 standard. As described in more detail of FIG. 8, various devices on a network can include components such as a processor, transceiver, user interface, etc. These components can be configured to process frames of data transmitted and/or received over a wireless network. Access points are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an ESS 130. The ESS 130 comprises two separate basic service sets, for example, BSS 1 140 and BBS 2 150. The ESS 130, the BSS 1 140, and the BSS 2 150 all broadcast and are configured with the same SSID “WiFi Name”, which can be a BSSID for each of the BSS 1 140 and the BSS 2 150 as well as an Extended Service Set Identifier (ESSID) for the ESS 130.

Within the first BSS 1 140, the network comprises a plurality of devices, for example, a first notebook 141, a second notebook 142, a first phone 143, a second phone 144, and a third notebook 160. Each of these devices can communicate with a first access point 145. Likewise, within the second BSS 2 150, the network comprises a plurality of devices, for example, a first tablet 151, a fourth notebook 152, a third phone 153, and a first watch 154. Each of these devices can communicate with a second access point 155. The third notebook 160 is communicatively connected to both the first BSS 1 140 and the second BSS 2 150. In this setup, the third notebook 160 can be seen to roam from the physical area serviced by the first BSS 1 140 into the physical area serviced by the second BSS 2 150. Any of the aforementioned devices, including the first and second notebooks, as well as the first, second, and third phones, may be substituted with similar devices, such as tablets or laptops, without departing from the spirit and scope of the present disclosure. For instance, a laptop and a notebook may be considered synonymous in many embodiments.

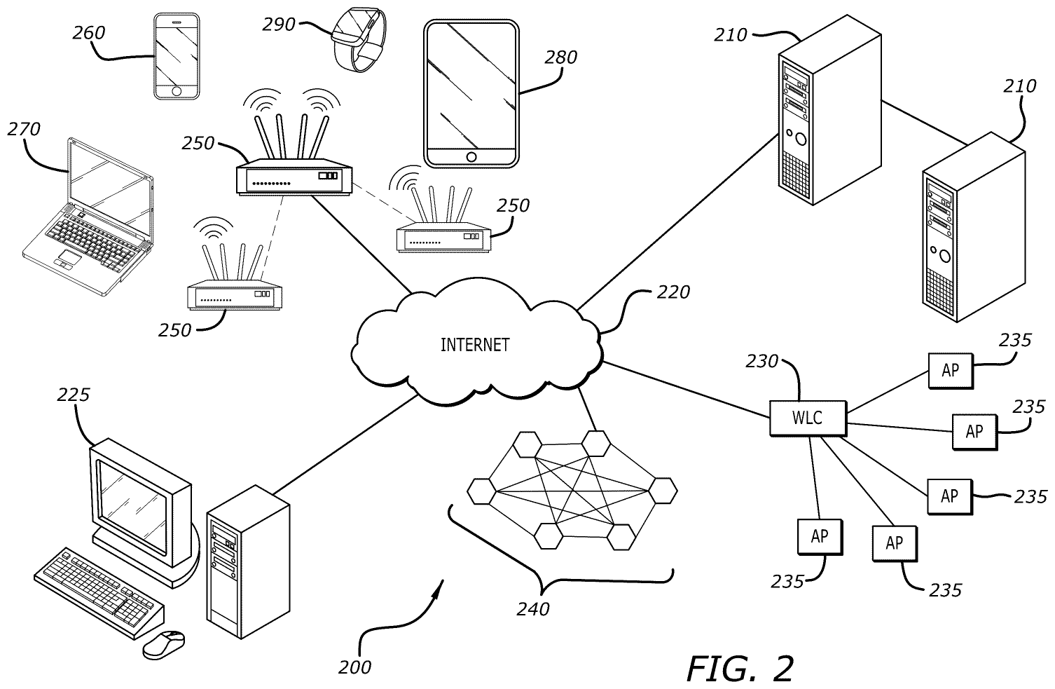

Although a specific embodiment for a wireless local networking system 100 suitable for carrying out the various steps, processes, methods, and operations described herein is discussed with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-8 as required to realize a particularly desired embodiment.

Referring to FIG. 2, a conceptual network diagram 200 of various environments in which a network management logic may operate on a plurality of network devices in accordance with various embodiments of the disclosure is shown. Those skilled in the art will recognize that the network management logic can include various hardware and/or software deployments and can be configured in a variety of ways. In many embodiments, the network management logic can be configured as a standalone device, exist as a logic in another network device, be distributed among various network devices operating in tandem, or remotely operated as part of a cloud-based network management tool. In a number of embodiments, one or more servers 210 can be configured with the network management logic or can otherwise operate as the network management logic. In a variety of embodiments, the network management logic may operate on one or more servers 210 connected to a communication network 220 (shown as the “Internet”). The communication network 220 can include wired networks or wireless networks. The network management logic can be provided as a cloud-based service that can service remote networks, such as, but not limited to a deployed network 240.

However, in various embodiments, the network management logic may be operated as a distributed logic across multiple network devices. In the embodiment depicted in FIG. 2, a plurality of network access points (denoted as “APs”) 250 can operate as the network management logic in a distributed manner or may have one specific device operate as the network management logic for all the neighboring or sibling access points 250. The access points 250 may facilitate Wi-Fi® connections for various electronic devices, such as but not limited to, mobile computing devices including cellular phones 260, laptop computers 270, portable tablet computers 280, and wearable computing devices 290.

In more embodiments, the network management logic may be integrated within another network device. In the embodiment depicted in FIG. 2, a wireless LAN controller (WLC) 230 may have an integrated networking logic that the WLC 230 can utilize to monitor or control power consumption of a plurality of access points 235 that the WLC 230 is connected to, either wired or wirelessly. In additional embodiments, a personal computer 225 may be utilized to access and/or manage various aspects of the network management logic, either remotely or within the network itself. In the embodiment depicted in FIG. 2, the personal computer 225 communicates over the communication network 220 and can access the network management logic of the servers 210, or the network access points 250, or the WLC 230.

Although a specific embodiment for various environments in which a network management logic may operate on a plurality of network devices suitable for carrying out the various steps, processes, methods, and operations described herein is discussed with respect to FIG. 2, any of a variety of systems and/or processes may be utilized in accordance with embodiments of the disclosure. For example, the network management logic may be provided as a device or a software separate from the WLC 230 or the network management logic may be integrated into the WLC 230. The elements depicted in FIG. 2 may also be interchangeable with other elements of FIG. 1 and FIGS. 3-8 as required to realize a particularly desired embodiment.

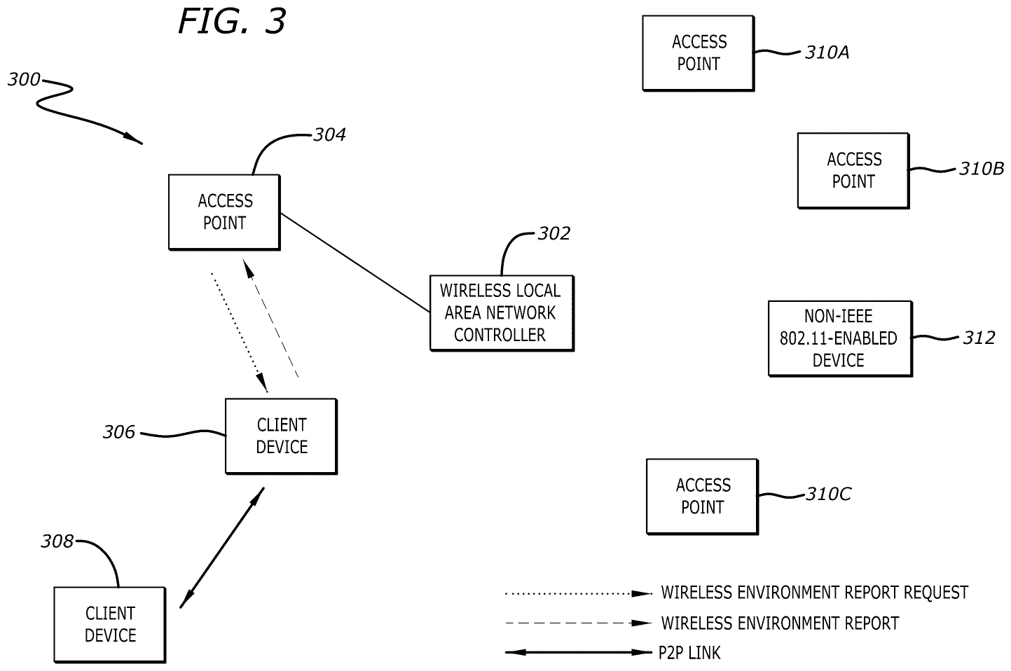

Referring to FIG. 3, a schematic block diagram of a wireless environment 300 showing augmented wireless environment reporting for optimizing wireless network management in accordance with various embodiments of the disclosure is shown. In many embodiments, the wireless environment 300 may deploy a WLAN. The WLAN may allow a plurality of devices to communicate with each other and connect to a network, for example, the Internet, wirelessly, within a relatively small geographic area such as a home, an office, or a campus. The WLAN may utilize radio waves to transmit data between the devices. In a number of embodiments, the devices in the WLAN may be configured to operate in accordance with the IEEE 802.11 wireless communication technology, for example, Wi-Fi® of the Wi-Fi Alliance Corporation. In WLAN deployments, there may be one or more wireless access points that serve wireless client devices, also known as STAs or clients. An STA may refer to any device including end-user devices such as laptops, smartphones, gaming consoles, wearable devices, other devices such as printers, Internet-of-Things (IoT) devices, or network infrastructure devices such as wireless mesh nodes, that can connect to the WLAN. In a variety of embodiments, all STAs in the WLAN may be configured to utilize the IEEE 802.11k standard to generate general beacon reports. A STA can either be in a client mode associated with an access point or in an access point mode acting as a network provider. When acting as a client device, the STA may connect to an access point to gain access to the network. For example, in FIG. 3, the STAs may be configured to operate as client devices 306 and 308 that may connect to an access point 304. In various embodiments, the client devices 306 and 308 may connect to the WLAN to utilize services and resources provided by servers, access points such as the access point 304, or other network devices. Examples of the client devices 306 and 308 may be laptops, tablets, dual-mode cellular phones, wireless Voice-over-Internet Protocol (VoIP) phones, personal digital assistants (e.g., converged devices that support WLAN data and/or voice, and cellular), gaming consoles, wearable devices, or the like.

In more embodiments, the WLAN may allow for wireless communication through the central access point 304 as well as direct wireless communication between the client devices 306 and 308 (e.g., a Peer-to-Peer “P2P” communication). In additional embodiments, the WLAN may include access points 304, 310A, 310B, and 310C, the client devices 306 and 308, and one or more wireless controllers such as a WLAN controller 302 as illustrated in FIG. 3. The client devices 306 and 308 may communicate in a network infrastructure of the WLAN via the access point 304.

The access points 304, 310A, 310B, and 310C may refer to networking devices, for example, wireless routers, that allow wireless-capable devices, for example, the client devices 306 and 308, to connect to a wired network. The wired network may be a wired local area network, for example, the Ethernet. The access points 304, 310A, 310B, and 310C may provide wireless connectivity to the client devices 306 and 308 and act as bridges between the WLAN and the wired network. In further embodiments, the access points 304, 310A, 310B, and 310C may broadcast the SSID of the WLAN and handle data traffic between the client devices 306 and 308 and the network infrastructure. Although the wireless environment 300 in FIG. 3 shows four access points 304, 310A, 310B, and 310C, the wireless environment 300 can include any number of access points. The access points 304, 310A, 310B, and 310C can communicate with each other to conduct operations in concert.

In still more embodiments, the WLAN controller 302 may be a computing device configured to manage and control actions of one or more access points, for example, the access points 304, 310A, 310B, and 310C, in the WLAN. In still further embodiments, data management and reporting responsibilities of the access points 304, 310A, 310B, and 310C, with respect to detected client devices 306 and 308 can be offloaded to the WLAN controller 302. Although the WLAN controller 302 is shown as a single computing device in FIG. 3, the WLAN controller 302 may represent multiple different computing devices either physically located near the access points 304, 310A, 310B, and 310C, or physically separate and accessed through one or more networks, for example, the Internet or a cloud.

In an example scenario illustrated in FIG. 3, the client device 306 may connect to the access point 304 to gain access to the WLAN. The access point 304 may be operably coupled the WLAN controller 302. Further, in still additional embodiments, the client device 306 can be connected to another client device 308 via a P2P link. In some more embodiments, the WLAN controller 302 may be configured to receive information related to the monitored transmissions from the access point 304, store data indicating when the client device 306 establishes a P2P link with another client device 308, forms a P2P group, or joins an existing P2P group. The access point 304 may also administer a locally unique P2P interface address for any P2P device. In yet various embodiments, by keeping track of a P2P interface and device address, the access point 304 or the wireless infrastructure including, for example, the WLAN controller 302 to which the access points 304, 310A, 310B, and 310C connect, can correctly track a P2P device, for example, the client device 306, as the P2P device joins different P2P groups.

In yet more embodiments, the WLAN may further include a non-IEEE 802.11-enabled device 312 configured to implement a non-IEEE 802.11 technology specification. The non-IEEE 802.11 technology specification may refer to wireless communication standards that are not part of the IEEE 802.11 family, including, for example, Bluetooth® of Bluetooth Sig, Inc., ZigBee® of ZigBee Alliance Corporation, Z-Wave© of the Z-wave Alliance, Inc., Near Field Communication (NFC), cellular technologies such as Long Term Evolution (LTE), fifth generation (5G) mobile communication, sixth generation (6G) mobile communication, XG-enabled mobile communication (where XG may refer to any future generation of mobile communication), etc., WiMAX® of the WiMAX Forum, or the like. The non-IEEE 802.11-enabled device 312 may connect to the WLAN by utilizing, for example, bridging devices, gateway devices, adapters, converters, Wi-Fi®-enabled devices, wired connections, or the like.

The IEEE 802.11k standard may allow the client device 306 to request information from the connected access point 304 about neighboring access points 310A, 310B, and 310C (typically on the same Extended Service Set “ESS”), in the form of 802.11k neighbor reports to assist in making intelligent roaming decisions. When the client device 306 requests a wireless environment report using the 802.11k standard, for example, an 802.11k neighbor report, from the access point 304, in addition to transmitting information including, for example, a BSSID of the access point 304, an SSID, channel information, maximum (max)/minimum (min) information, or the like, to the client device 306, the access point 304 may further augment the wireless environment report to include extended information based on several parameters and/or conditions, that is useful to the network infrastructure and that may help in network analytics and various network management tasks.

The 802.11k standard may also allow the access point 304 to request information from the client device 306, for example, in the form of an 802.11k beacon report, requesting the client device 306 to scan (actively or passively) one or more channels or bands, and report on the access points detected in those channels or bands. The access point 304 can also request the client device 306 to merely share a result from a previous scan or a recent scan. The client device 306 can be requested to report on all detected access points associated with any SSID, or only on a single SSID with which the client device 306 is associated. In addition to providing a view of the wireless environment 300 from the perspective of the client device 306, the 802.11k beacon report may be augmented to provide extended information that is useful to the network infrastructure and that may help the client device 306 in multiple other dimensions and various network management tasks.

In still yet more embodiments, a network management logic configured to augment wireless environment reporting in the wireless environment 300 can be implemented in the access point 304, the client device 306, and/or the WLAN controller 302 to optimize wireless network management. In many further embodiments, the access point 304 may generate a wireless environment report request including at least one of a condition, a P2P technology specification, a non-IEEE 802.11 technology specification, or an element restriction. The access point 304 may transmit the generated wireless environment report request to the client device 306. The client device 306 may generate the wireless environment report based on the wireless environment report request. For example, the client device 306 may generate the wireless environment report associated with at least one of the condition, the P2P technology specification, the non-IEEE 802.11 technology specification, or the element restriction, included in the wireless environment report request. The client device 306 may transmit the generated wireless environment report to the access point 304. The access point 304 may receive the generated wireless environment report.

In many additional embodiments, the client device 306 (herein referred to as a “requesting client device”) may generate a wireless environment report request including at least one of a condition, a P2P technology specification, a non-IEEE 802.11 technology specification, or an element restriction. The requesting client device 306 may transmit the generated wireless environment report request to another client device 308 (herein referred to as a “responding client device”) via the P2P link. The responding client device 308 may generate the wireless environment report based on the wireless environment report request. For example, the responding client device 308 may generate the wireless environment report associated with at least one of the condition, the P2P technology specification, the non-IEEE 802.11 technology specification, or the element restriction, included in the wireless environment report request. The responding client device 308 may transmit the generated wireless environment report to the requesting client device via the P2P link. The requesting client device 306 may receive the transmitted wireless environment report from the responding client device 308 via the P2P link.

Although a specific embodiment for a wireless environment showing augmented wireless environment reporting for optimizing wireless network management suitable for carrying out the various steps, processes, methods, and operations described herein is discussed with respect to FIG. 3, any of a variety of systems and/or processes may be utilized in accordance with embodiments of the disclosure. For example, the access point 304 may be configured to operate as a standalone access point that may provide connectivity between various wireless client devices, or a multifunction access point that may operate as a combination of two or more access points, or a controlled access point that may operate as a client device of the WLAN controller 302. The elements depicted in FIG. 3 may also be interchangeable with other elements of FIGS. 1-2 and FIGS. 4-8 as required to realize a particularly desired embodiment.

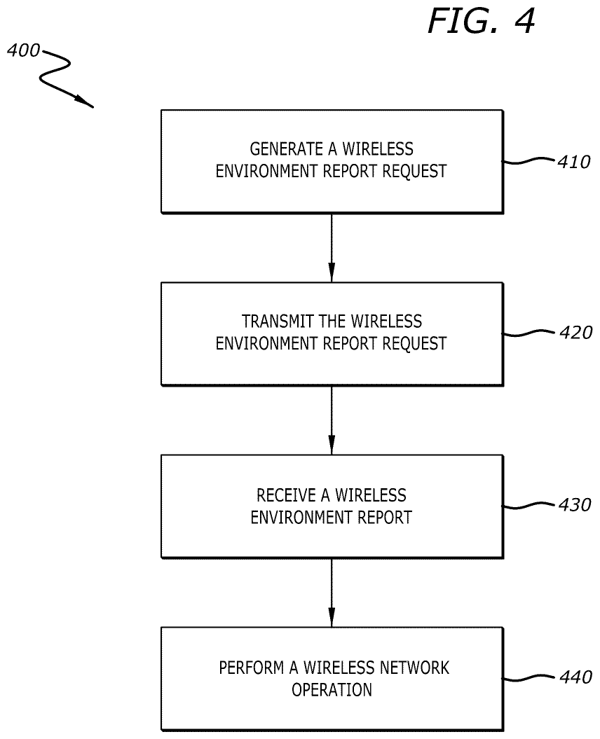

Referring to FIG. 4, a flowchart depicting a process 400 for augmented wireless environment reporting from the perspective of an access point in accordance with various embodiments of the disclosure is shown. The process 400 may implement an augmented mechanism for allowing a client device to provide extended reports based on the IEEE 802.11k standard, also referred to as “802.11k reports”, to an access point and in turn to a network infrastructure to assist with wireless network management and improve experience of all client devices in a wireless environment.

In many embodiments, the process 400 may generate a wireless environment report request (block 410). The wireless environment report request may be in the form of an 802.11 management frame known as an action frame. The action frame may be a type of management frame utilized for exchanging specific control information between devices. The action frame may be configured to facilitate different types of actions or operations within a wireless environment. The action frame may be utilized for communicating specific commands or requests between access points and client devices, or between access points. The wireless environment report request may be a request for a conditional report, a request for a report based on a particular technology specification, or a request for a report based on an element restriction. In a number of embodiments, the wireless environment report request may include at least one of a condition, a P2P technology specification, a non-IEEE 802.11 technology specification, or an element restriction.

In a variety of embodiments, the wireless environment report request may include a condition. The condition may refer to a particular set of criteria or rules based on which information should be reported to the access point. In various embodiments, the wireless environment report request may be configured to include a negative SSID or an excluded SSID, for example, as the condition. The negative SSID or the excluded SSID may refer to a Wi-Fi network identifier or an SSID that may be specifically excluded from a list of available networks or from a network scan. In more embodiments, the wireless environment report request may be configured to indicate an SSID and the condition associated with the SSID also referred to as a “conditional SSID statement”. In additional embodiments, the wireless environment report request may be configured to indicate a channel or a band. In further embodiments, the wireless environment report request may be configured to indicate reporting of a local SSID on the indicated channel or band. In an example, the wireless environment report request may include a condition “report non-blizzard SSIDs on a channel if Blizzard is also detected”. In another example, the process 400 may generate the wireless environment report request requesting a client device to scan a channel or a band and report all SSIDs detected, but only on channels where a local SSID was also detected. In another example, the process 400 may generate the wireless environment report request requesting the client device to scan a channel or a band and report systems detected on any channel where the local SSID is not detected.

In still more embodiments, the wireless environment report request may be configured to indicate an absence of a neighbor SSID on the indicated channel or band as the condition. In an example where an access point or the WLAN controller connected to the access point is aware of a neighboring system utilizing a form of Adaptive Radio Management (ARM)/Radio Resource Management (RRM), the process 400 may generate the wireless environment report request requesting a client device to scan a channel or a band, and report whether a local SSID is detected and whether the neighbor SSID is not reported.

In still further embodiments, the wireless environment report request can be a conditional beacon report request, which is useful for RRM and to detect rogues or neighboring access points that may disrupt operations of managed access points, and thus affect the roaming efficiency of a client device. In still additional embodiments, the conditional beacon report request may include threshold values. For example, the process 400 may generate the conditional beacon report request to report the number of access points the client device sees on SSID “blizzard” that have a Received Signal Strength Indicator (RSSI) greater than a first threshold value (e.g., 65 decibel milliwatts “dBm” or have a Signal-to-Noise Ratio (SNR) less than a second threshold value (e.g., 85 dBm).

In some more embodiments, the wireless environment report request may be further configured to indicate reporting of a result of a criteria-based evaluation. In yet various embodiments, the criteria-based evaluation may include one or more logical operations. For example, the process 400 may generate the wireless environment report request requesting a client device to perform a logical operation based on its 802.11k report and return the result of the logical operation. Examples of logical operations performed by client devices may include performing measurements of beacon frames received from neighboring access points, signal strength, and presence of specific SSIDs.

In yet more embodiments, the wireless environment report request may include a non-IEEE 802.11 technology specification. In these embodiments, the wireless environment report request may be further configured to indicate a channel or a band. In an example, the access point may generate the wireless environment report request requesting a client device to scan a channel or a band and report on active non-Wi-Fi radios that the client device utilizes or detects.

In some cases, the access point may have a fairly accurate view of the wireless environment, but may be missing a few elements including, for example, information about rogue access points on a different ESS, or some other elements of which the access point is unsure. In these cases, the access points may not need the full wireless environment report, but may only require certain fields of the wireless environment report. Thus, in still additional embodiments, in the generated wireless environment report request, the process 400 may indicate only necessary portions or elements of a wireless environment report or the process 400 may request only details about a certain access point that the access point cannot see clearly. In this case, the client device may only respond with the elements or fields requested by the access point. For example, the access point may request the client device to report whether a detected access point is a Very Low Power (VLP) system, thereby facilitating the detection of ad-hoc or low power systems.

In still yet more embodiments, the wireless environment report request may include an element restriction. For example, the process 400 may allow the access point to generate a specialized neighbor report request, as the wireless environment report request, that includes an information element configured to indicate the type of detection requested from the client device. The information element may refer to a data structure utilized in network protocols to convey information about network devices, services, or parameters. Information elements may be included in management frames of Wi-Fi protocols to provide additional information beyond a basic frame structure. For example, in the 802.11 protocol, information elements are utilized in frames such as beacon frames, probe requests, and probe responses to communicate details about network capabilities, supported data rates, and other attributes. In an example, the information element may include elements such as a Datagram Transport Layer Security (DTLS) pair. In another example, the information element may include an element such as a P2P system, where the client device may communicate with another client device through a P2P protocol such as a Neighbor Awareness Networking (NAN) protocol, a DTLS protocol, or the like. In many additional embodiments, the information element IE may also extend a multiband operation (MBO), other radio technology report, request the client device to scan a channel or a band, and report on active non-Wi-Fi radio, for example, Ultrawide Band (UWB) or a Bluetooth Low Energy (BLE) radio, that the client device utilizes or detects.

In still yet further embodiments, the process 400 may transmit the wireless environment report request (block 420). In still yet additional embodiments, the wireless environment report request may be transmitted to a client device. The wireless environment report request may be generated by the access point and transmitted to the client device. In several embodiments, the wireless environment report request may be generated by the WLAN controller based on data provided by the access point and transmitted from the WLAN controller to the client device via the access point. In several more embodiments, the wireless environment report request may be generated by the WLAN controller based on data provided by the access point and transmitted directly from the WLAN controller to the client device.

In numerous embodiments, the process 400 may receive a wireless environment report (block 430). In numerous additional embodiments, the wireless environment report may be received from the client device based on the transmitted wireless environment report request. For example, the wireless environment report may be associated with at least one of the condition, the P2P technology specification, the non-IEEE 802.11 technology specification, or the element restriction included in the wireless environment report request. In cases where the wireless environment report request indicates only necessary portions of the wireless environment report or only details about the certain access point that the access point cannot see clearly, the received wireless environment report may only include the elements or fields requested in the wireless environment report request. For example, the process 400 may have requested the client device to report whether a detected access point is a VLP system. In such a scenario, the received wireless environment report may only include information indicating whether the detected access point is a VLP system or not, thereby facilitating the detection of ad-hoc or low power systems.

In some more embodiments, the process 400 may perform a wireless network operation (block 440). The wireless environment report may provide a Radio Frequency (RF) view of a client device, which can help extend an access point view to the ground. The wireless environment report may, therefore, provide information that may be useful to the network infrastructure to help the access point in performing wireless network operations. For example, if the wireless environment report indicates high interference or poor signal quality on a current channel, the access point may switch to a less congested channel to improve performance and reduce interference. In another example, the access point can adjust its transmit power based on the reported signal strength and interference levels, which may minimize interference with neighboring access points. In another example, if the wireless environment report indicates that certain access points are overloaded, the access point may assist in load balancing by directing client devices to less congested access points or coordinating with other access points to manage client distribution. In yet another example, the access point may adjust a beacon interval or other timing parameters to optimize network efficiency and reduce overhead based on the wireless environment report.

Although a specific embodiment for a process 400 for augmented wireless environment reporting from the perspective of an access point suitable for carrying out the various steps, processes, methods, and operations described herein is discussed with respect to FIG. 4, any of a variety of systems and/or processes may be utilized in accordance with various embodiments of the disclosure. For example, instead of the access point executing the generation of the wireless environment report request, the access point may offload the report request generation function to a WLAN controller or another server in the wireless network infrastructure based on data supplied from the access point and/or one or more access points that monitor transmissions from the client devices in the WLAN. The elements depicted in FIG. 4 may also be interchangeable with other elements of FIGS. 1-3 and FIGS. 5-8 as required to realize a particularly desired embodiment.

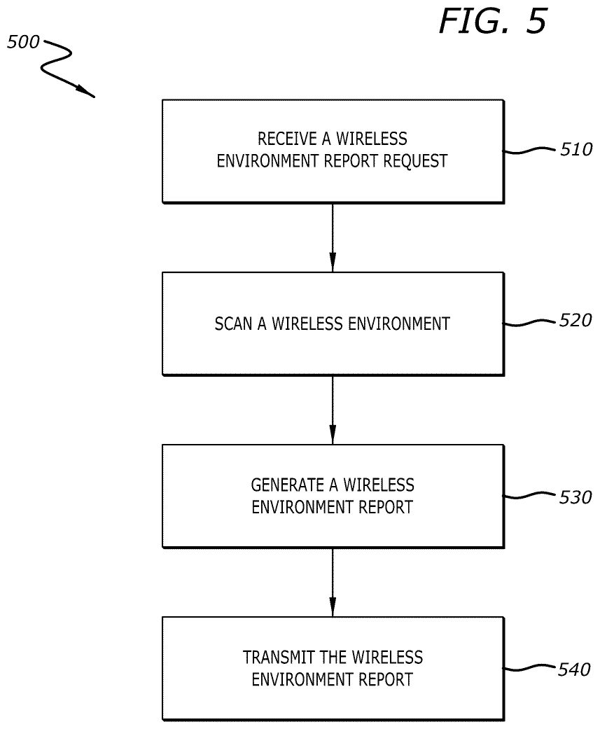

Referring to FIG. 5, a flowchart depicting a process 500 for augmented wireless environment reporting from the perspective of a station in accordance with various embodiments of the disclosure is shown. In many embodiments, the STA can be configured to operate in a client mode associated with an access point. That is, the STA may be configured to operate as a client device that may connect to an access point in a wireless environment.

In a number of embodiments, the process 500 may receive a wireless environment report request (block 510). The process 500 may receive the wireless environment report request from the access point. The wireless environment report request may be received by the client device connected to the access point. In a variety of embodiments, the wireless environment report request may be a request for a conditional report. In various embodiments, the wireless environment report request may be a request for a report based on a particular technology specification, for example, a P2P technology specification, a non-IEEE 802.11 technology specification, or the like. In more embodiments, the wireless environment report request may be a request for a report based on an element restriction including, for example, a DTLS pair or a P2P pair. In an embodiment, the wireless environment report request may include a P2P technology specification, for example, “report P2P pairs on this channel”.

In additional embodiments, the process 500 may scan a wireless environment (block 520). The wireless environment may be scanned by the client device. The process 500 may scan the wireless environment based on the received wireless environment report request. In an example, the wireless environment report request may indicate an SSID, a condition associated with the SSID, and a channel or a band. In this example, based on the indications in the wireless environment report request, the process 500 may scan the indicated channel or band to detect all SSIDs, but only on channels where a local SSID was also detected. In another example, based on the indications in the wireless environment report request, the process 500 may scan the indicated channel or band to detect systems on any channel where the local SSID is not detected. In another example, based on the indications in the wireless environment report request, the process 500 may scan the indicated channel or band to detect P2P pairs on the indicated channel or band.

In further embodiments, the process 500 may generate a wireless environment report (block 530). The wireless environment report may be generated by the client device. The process 500 may generate the wireless environment report based on the result of scanning the wireless environment in response to the wireless environment report request. For example, for a wireless environment report request that may indicate an SSID, a condition associated with the SSID, and a channel or a band, based on the result of scanning the indicated channel or band, the process 500 may report all SSIDs detected, but only on channels where a local SSID was also detected. In another example, based on the result of scanning the indicated channel or band, the process 500 may generate the wireless environment report indicating systems on any channel where the local SSID is not detected. In another example, based on the result of scanning the indicated channel or band, the process 500 may generate the wireless environment report indicating the detected P2P pairs on the requested channel or band.

In still more embodiments, the process 500 may generate the wireless environment report based on the condition included in the wireless environment report request. In still further embodiments, the process 500 may generate the wireless environment report based on an excluded SSID indicated in the wireless environment report request. In still additional embodiments, the process 500 may generate the wireless environment report based on an SSID and the condition associated with the SSID that are indicated in the wireless environment report request. In some more embodiments, the process 500 may generate the wireless environment report based on a channel or a band indicated in the wireless environment report request. For example, for a wireless environment report request requesting the client device to scan a channel or a band and report all SSIDs detected, but only on channels where a local SSID was also detected, the process 500 may generate the wireless environment report that may be utilized to detect rogues that may be at the edge of other BSSs. In another example, for a wireless environment report request requesting the client device to scan a channel or a band and report systems detected on any channel where the local SSID is not detected, the process 500 may generate the wireless environment report that may be utilized for RRM to predict the most efficient channel change, especially in scenarios where directional antennas prevent neighboring access points from detecting each other.

In yet various embodiments, the process 500 may generate the wireless environment report to report a local SSID on the indicated channel or band. In yet more embodiments, the process 500 may generate the wireless environment report to report an absence of a neighbor SSID on the indicated channel or band. For example, for a wireless environment report request requesting the client device to scan a channel or a band, and report whether a local SSID is detected and whether the neighbor SSID is not reported, the process 500 may generate the wireless environment report that may be utilized to direct roaming client devices to channels unaffected by a neighboring system.

In still yet more embodiments, the process 500 may generate the wireless environment report to report a result of a criteria-based evaluation which may include one or more logical operations. For example, the client device may generate the wireless environment report including metrics of beacon frames received from neighboring access points, signal strength, and presence of specific SSIDs. In many further embodiments, the process 500 may generate the wireless environment report based on a non-IEEE 802.11 technology specification included in the wireless environment report request, which may indicate a channel or a band. For example, for a wireless environment report request requesting the client device to scan a channel or a band and report on active non-Wi-Fi radio that the client device utilizes or detects, the client device may generate a wireless environment report such as an MBO, other radio technology report that may be utilized to detect an active use of UWB or a BLE radio by the client device.

In many additional embodiments, the process 500 may generate the wireless environment report based on an element restriction included in the wireless environment report request. For example, for a specialized neighbor report request that may include an information element such as a DTLS pair or a P2P system, configured to indicate the type of detection requested from the client device, the client device may generate a specialized neighbor report that may be utilized by the access point to schedule time for a P2P exchange, detect the P2P density in a cell and thus its effect on the BSS available airtime, or notify the RRM for channel allocation.

In an example, on receiving the wireless environment report request including threshold values such as an RSSI greater than a first threshold value (e.g., 65 dBm) or an SNR less than a second threshold value (e.g., 85 dBm), the process 500 may generate the wireless environment report indicating the number of access points the client device sees on SSID “blizzard” with the requested threshold values. In another example where an access point or the WLAN controller connected to the access point is aware of a neighboring system utilizing a form of ARM/RRM, the client device may scan a channel or a band indicated in the wireless environment report request and generate the wireless environment report indicating whether a local SSID is detected and whether a neighbor SSID is not reported. In another example, the process 500 may generate the wireless environment report indicating the detected P2P pairs on the indicated channel or band.

In still yet further embodiments, the process 500 may transmit the wireless environment report (block 540). The process 500 may transmit the wireless environment report to the access point. In various embodiments, the process 500 may transmit the wireless environment report to a WLC. In various additional embodiments, the process 500 may transmit the wireless environment report to the WLC via the access point.

Although a specific embodiment for a process 500 for augmented wireless environment reporting from the perspective of a STA suitable for carrying out the various steps, processes, methods, and operations described herein is discussed with respect to FIG. 5, any of a variety of systems and/or processes may be utilized in accordance with embodiments of the disclosure. For example, the STA or the client device may share its updated wireless environment report in an unsolicited way when the STA or the client device sees significant changes to the WLAN. The elements depicted in FIG. 5 may also be interchangeable with other elements of FIGS. 1-4 and FIGS. 6-8 as required to realize a particularly desired embodiment.

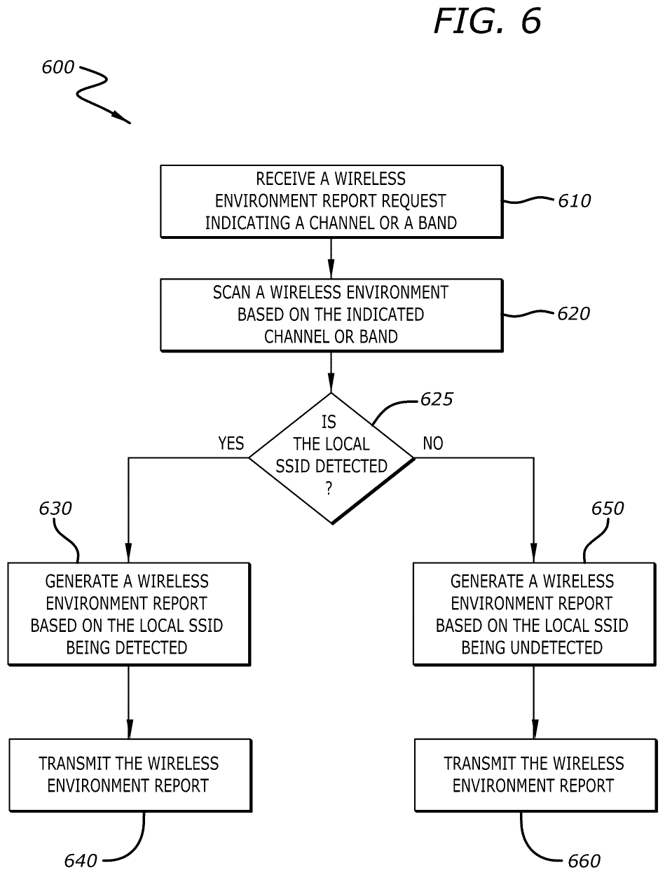

Referring to FIG. 6, a flowchart depicting a process 600 for augmented wireless environment reporting based on detection of a local SSID from the perspective of a station in accordance with various embodiments of the disclosure is shown. In many embodiments, the STA may be configured to operate as a client device that may connect to an access point in a wireless environment.

In a number of embodiments, the process 600 may receive a wireless environment report request indicating a channel or a band (block 610). The wireless environment report request may be received by the client device from the access point. In a variety of embodiments, the wireless environment report request may be configured to indicate reporting of a local SSID on the indicated channel or band. In various embodiments, the wireless environment report request may be configured to indicate reporting of all local SSIDs on the indicated channel or band based on the local SSID being detected on the indicated channel or band. In more embodiments, the wireless environment report request may be configured to indicate reporting of all local SSIDs on the indicated channel or band based on the local SSID being undetected on the indicated channel or band.

In additional embodiments, the process 600 may scan a wireless environment based on the indicated channel or band (block 620). The wireless environment may be scanned by the client device. The process 600 may scan the wireless environment based on the received wireless environment report request. In the above example, based on the indications in the wireless environment report request, the process 600 may scan the channel or the band to detect all SSIDs, but only on channels where the local SSID was also detected. In another example, based on the indications in the wireless environment report request, the process 600 may scan the channel or the band to detect systems on any channel where the local SSID is not detected. The process 600 may initiate the scan to find available wireless networks identified by their SSIDs, which may be triggered automatically by an operating system of the client device, for example.

Wi-Fi networks may operate on specific frequency bands, for example, 2.4 gigahertz (GHz), 5 GHz, 6 GHz, Extended 6 GHz, or the like. In yet various embodiments, the process 600 may scan each channel within these bands to discover available wireless networks. In still more embodiments, the process 600 may execute passive scanning of the indicated channel or band by listening for beacon frames broadcasted by neighboring access points. Beacon frames may refer to management frames that include the local SSID and other network information. The client device may listen on each channel for a certain period, capturing beacon frames from the access points that are broadcasting their presence. In still further embodiments, the process 600 may execute active scanning of the indicated channel or band by transmitting probe requests on the indicated channel or band. These probe requests may refer to management frames that request for responses from any neighboring access points that match the requested SSID or support general SSID discovery. The access points that receive the probe requests may respond with probe response frames, which include the SSID and other information about the wireless network. The client device may extract the SSID from the beacon frames or the probe response frames. The SSID may be part of the payload of a frame and may be utilized to identify the wireless network. Additional information such as signal strength, supported data rates, security protocols, and network capabilities may also be gathered from the received frames.

In further embodiments, the process 600 may determine whether the local SSID is detected (block 625). The process 600 may determine whether the local SSID is detected based on the scanning of the wireless environment in accordance with the received wireless environment report request. In still additional embodiments, in response to determining that the local SSID is detected, the process 600 may generate a wireless environment report based on the local SSID being detected (block 630). The wireless environment report may be generated by the client device. Based on the wireless environment report request, the wireless environment report may include all SSIDs detected on channels where the local SSID was also detected. In some more embodiments, the process 600 may generate the wireless environment report to report all local SSIDs on the indicated channel or band based on the local SSID being detected on the indicated channel or band. For example, the client device may extract the local SSIDs from the beacon frames or the probe response frames received from the neighboring access points and include the local SSIDs in the wireless environment report.

In yet various embodiments, the process 600 may transmit the wireless environment report (block 640). The process 600 may transmit the wireless environment report from the client device to the access point. In yet more embodiments, to transmit the wireless environment report to the access point, the client device may utilize an action frame with a category of, for example, “Radio Measurement” or “Measurement Report”. The action frame utilized for transmitting the wireless environment report may include a header with frame control and address fields and a payload that includes the report data.

However, in still yet more embodiments, in response to determining that the local SSID is undetected, the process 600 may generate a wireless environment report based on the local SSID being undetected (block 650). Based on the wireless environment report request, the wireless environment report may include systems detected on any channel where the local SSID is not detected. In many further embodiments, the client device may generate the wireless environment report to report all local SSIDs on the indicated channel or band based on a local SSID being undetected on the indicated channel or band. In many additional embodiments, the process 600 may transmit the wireless environment report (block 660). The process 600 may transmit the wireless environment report from the client device to the access point.

Although a specific embodiment for a process 600 for augmented wireless environment reporting based on detection of a local SSID from the perspective of a station suitable for carrying out the various steps, processes, methods, and operations described herein is discussed with respect to FIG. 6, any of a variety of systems and/or processes may be utilized in accordance with embodiments of the disclosure. For example, STAs or client devices may offer their wireless environment reports, that is, the IEEE 802.11k reports to the network infrastructure in an unsolicited way, that is, issuing the wireless environment reports on a regular basis even without an action frame. The elements depicted in FIG. 6 may also be interchangeable with other elements of FIGS. 1-5 and FIGS. 7-8 as required to realize a particularly desired embodiment.

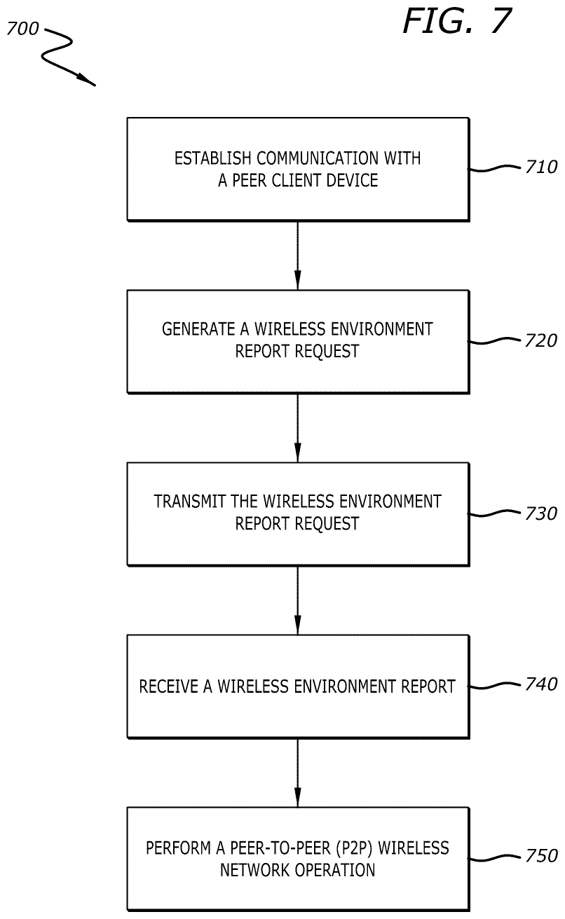

Referring to FIG. 7, a flowchart depicting a process 700 for augmented wireless environment reporting between peer client devices in accordance with various embodiments of the disclosure is shown. In many embodiments, P2P client devices may request a wireless environment report, for example, an IEEE 802.11k report, from each other to gain a better perspective on how their peers are viewing the wireless environment, thereby allowing the P2P client devices to select better radio parameters.

In a number of embodiments, the process 700 may establish communication with a peer client device (block 710). The established communication, for example, a P2P communication, may refer to transmissions and interactions between two peer client devices over a wireless network, for example, a WLAN. In a variety of embodiments, client devices attempting to establish the P2P communication may first scan for available networks and neighboring client devices. These client devices in the WLAN may utilize standard Wi-Fi scanning mechanisms to discover potential peer client devices and their capabilities and establish the P2P communication. These standard Wi-Fi scanning mechanisms may allow the client devices to connect directly to each other without a central access point. For example, the client devices may utilize Wi-Fi Direct® to discover other client devices that support P2P communication and establish a P2P link therebetween. The client devices may exchange queries and responses to identify potential peers. The client devices on the P2P link interact directly with each other. In another example, a client device may establish a communication with a peer client device through P2P protocols such as a NAN protocol, a DTLS protocol, or the like. The NAN protocol may refer to a specification configured to facilitate direct P2P communication between client devices in close proximity without requiring a conventional network infrastructure. The DTLS protocol may be configured to provide security for datagram-based applications, such as those using a User Datagram Protocol (UDP).

In various embodiments, the process 700 may generate a wireless environment report request (block 720). In various additional embodiments, the wireless environment report request may include at least one of a condition, a non-IEEE 802.11 technology specification, or an element restriction. In more embodiments, the wireless environment report request may include a P2P technology specification. The P2P technology specification may define protocols, standards, and methodologies for establishing a direct communication and interaction between client devices in a wireless network, for example, a WLAN, without the need for a central access point, a central server, or an intermediary. In additional embodiments, the wireless environment report request may be configured to indicate reporting of a number of P2P pairs. In a P2P system, each P2P pair may include two peer client devices that have established a direct P2P communication channel therebetween. These two peer client devices can exchange data directly without relying on any central infrastructure or intermediaries. On discovering each other through a scanning process, two client devices may negotiate parameters including, for example, connection security, data rates, and protocols to establish a connection and form a P2P pair. In further embodiments, the two client devices may authenticate each other by exchanging credentials or secure keys to establish a secure P2P communication and form the P2P pair. In an embodiment where the wireless environment report request includes the P2P technology specification, the process 700 may allow the client device to request a conditional report including, for example, “report P2P pairs on this channel”. In still more embodiments, the process 700 may allow the client device to request a conditional report from a peer client device. For example, the conditional report request may include “report the number of access points that a peer client device sees on an a particular SSID, that have an RSSI greater than a first threshold value (e.g., 65 dBm) or an SNR less than a second threshold value (e.g., 85 dBm).”

In still further embodiments, the process 700 may transmit the wireless environment report request (block 730). The wireless environment report request may be transmitted from the client device to its peer client device. The process 700 may transmit the wireless environment report request to the peer client device via the P2P link established between the peer client devices. In still additional embodiments, to transmit the wireless environment report to the peer client device, the client device may utilize an action frame with a category of, for example, “Radio Measurement” or “Measurement Report”. The action frame utilized for transmitting the wireless environment report may include a header with frame control and address fields and a payload that includes the report data.

In some more embodiments, the process 700 may receive a wireless environment report (block 740). The process 700 may receive the wireless environment report based on the transmitted wireless environment report request from the peer client device via the P2P link. In an example, for a wireless environment report request including the P2P technology specification, the wireless environment report may report the number of P2P pairs on an indicated channel. Understanding the number of P2P pairs helps in assessing how bandwidth is being utilized. A high number of P2P connections may lead to network congestion and reduced performance, especially if many devices are communicating directly with each other. The wireless environment report may provide a better perspective on how the peer client device is viewing the wireless environment, allowing the peer client device to select better radio parameters. In another example, for a wireless environment report request including the P2P technology specification, the wireless environment report may include, for example, the number of access points that a peer client device sees on an a particular SSID with the indicated threshold values such as an RSSI greater than the first threshold value (e.g., 65 dBm) or an SNR less than the second threshold value (e.g., 85 dBm). In some cases, the client device may not need the full wireless environment report from the peer client device, but may only require certain fields of the wireless environment report. Thus, in another example, in the wireless environment report may include only necessary portions of a wireless environment report or only details about a certain access point that the access point cannot see clearly. In this case, the peer client device may only respond with the elements or fields requested by the client device in the wireless environment report request. In yet various embodiments, the wireless environment report may be associated with the condition, the non-IEEE 802.11 technology specification, or the element restriction included in the wireless environment report request.

In yet various embodiments, the process 700 may perform a P2P wireless network operation (block 750). The process 700 may perform a P2P wireless network operation based on the received wireless environment report. For example, on receiving the wireless environment report indicating the number of P2P pairs on an indicated channel, the process 700 may analyze P2P pair distribution, identify areas with high P2P activity, and implement measures to balance the load across the network, for example, by adjusting access points or optimizing network settings. Examples of P2P wireless network operations may include scanning for available channels and selecting a channel with minimal interference from other networks or peer client devices, selecting between 20 megahertz (MHz), 40 MHz, 80 MHz, or 160 MHz channel widths, dynamically adjusting transmit power of the client device based on a distance from the access point or other peer client devices to balance coverage and avoid interference, selecting data rates based on the quality of the connection and signal strength, selecting between the 2.4 GHz and 5 GHz bands based on factors such as signal strength, congestion, and the type of applications being utilized, selecting parameters that prioritize critical traffic, creation of ad-hoc P2P networks, or the like. In yet more embodiments, the wireless environment report may be utilized by an access point to schedule time for a P2P exchange, detect a P2P density in a cell and thus its effect on the BSS available airtime, or notify RRM for channel allocation. In still yet more embodiments, based on the wireless environment report, the process 700 may perform other network operations such as P2P detection, detection of unusable channels, detection of VLP systems, and detection of other local RF events that may degrade the experience of the client device but are not directly visible to the access point.

Although a specific embodiment for a process 700 for augmented wireless environment reporting between peer client devices suitable for carrying out the various steps, processes, methods, and operations described herein is discussed with respect to FIG. 7, any of a variety of systems and/or processes may be utilized in accordance with embodiments of the disclosure. For example, in addition to establishing communication with a single peer client device for requesting a single wireless environment report, the STA or client device may establish communication with a plurality of groups of peer client devices simultaneously and transmit multiple distinct wireless environment report requests to the groups for receiving augmented information that may be useful to the network infrastructure. The elements depicted in FIG. 7 may also be interchangeable with other elements of FIGS. 1-6 and FIG. 8 as required to realize a particularly desired embodiment.

Referring to FIG. 8, a conceptual block diagram of a device 800 capable of executing components and logic for implementing the functionality and embodiments described above is shown. The embodiment of the conceptual block diagram depicted in FIG. 8 can illustrate a conventional server computer, a workstation, a desktop computer, a laptop, a tablet, a network appliance, an electronic reader (e-reader), a smartphone, or other computing device, and can be utilized to execute any of the application and/or logic components presented herein. The device(s) 800 may, in some examples, correspond to physical devices or to virtual resources described herein. The embodiment of the conceptual block diagram depicted in FIG. 8 can also illustrate an access point, a WLC, a client device, or the like in accordance with various embodiments of the disclosure. The device 800 may, in many non-limiting examples, correspond to physical devices or virtual resources described herein.

In many embodiments, the device 800 may include an environment 802 such as a baseboard or a “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In a number of embodiments, one or more processors 804, such as, but not limited to, central processing units (CPUs) can be configured to operate in conjunction with a chipset 806. The processor(s) 804 can be standard programmable CPUs that perform arithmetic and logical operations necessary for the operation of the device 800.

In a variety of embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to a random-access memory (RAM) 808, which can be utilized as the main memory in the device 800 in some embodiments. The chipset 806 can further be configured to provide an interface to a computer-readable storage medium such as a read-only memory (ROM) 810 or a non-volatile RAM (NVRAM) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Different embodiments of the device 800 can be configured to operate in a networked environment using logical connections to remote computing devices and computer systems through a network, such as the network 840. The chipset 806 can include functionality for providing network connectivity through a network interface controller (NIC) 812, which may include a gigabit Ethernet adapter or similar component. The NIC 812 can be capable of connecting the device 800 to other devices over the network 840. It is contemplated that multiple NICs 812 may be present in the device 800, connecting the device 800 to other types of networks and remote systems.

In more embodiments, the device 800 can be connected to a storage 818 that provides non-volatile storage for data accessible by the device 800. The storage 818 can, for example, store an operating system 820, applications or programs 822, report request data 828, report data 830, and wireless environment data 832, which are described in greater detail below. The storage 818 can be connected to the environment 802 through a storage controller 814 connected to the chipset 806. In additional embodiments, the storage 818 can include one or more physical storage units. The storage controller 814 can interface with the physical storage units through a serial attached SCSI (SAS) interface, a serial advanced technology attachment (SATA) interface, a fiber channel (FC) interface, or other type of interface for physically connecting and transferring data between computers and physical storage units.

The device 800 can store data within the storage 818 by transforming the physical state of the physical storage units to reflect the information being stored. The specific transformation of physical state can depend on various factors. Examples of such factors can include, but are not limited to, the technology utilized to implement the physical storage units, whether the storage 818 is characterized as primary or secondary storage, and the like.

For example, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to the device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (EPROM), electrically-erasable programmable ROM (EEPROM), flash memory or other solid-state memory technology, compact disc ROM (CDROM), digital versatile disk (DVD), high definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 818 can store an operating system 820 utilized to control the operation of the device 800. According to one embodiment, the operating system 820 includes the LINUX operating system. According to another embodiment, the operating system 820 includes the WINDOWS® SERVER operating system from MICROSOFT Corporation of Redmond, Washington. According to further embodiments, the operating system 820 can include the UNIX operating system or one of its variants. It should be appreciated that other operating systems can also be utilized. The storage 818 can store other system or application programs and data utilized by the device 800.

In further embodiments, the storage 818 or other computer-readable storage media is encoded with computer-executable instructions which, when loaded into the device 800, may transform the device 800 from a general-purpose computing system into a special-purpose computer capable of implementing the embodiments described herein. These computer-executable instructions may be stored as applications or programs 822 and transform the device 800 by specifying how the processor(s) 804 can transition between states, as described above. In still more embodiments, the device 800 has access to computer-readable storage media storing computer-executable instructions which, when executed by the device 800, perform the various processes described above with regard to FIGS. 1-8. In still further embodiments, the device 800 can also include computer-readable storage media having instructions stored thereupon for performing any of the other computer-implemented operations described herein.

In still additional embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 may not include all of the components shown in FIG. 8, and can include other components that are not explicitly shown in FIG. 8, or may utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein. In some more embodiments, the device 800 can include a network management logic 824 that may be responsible for augmenting wireless environment reporting for optimizing wireless network management. The network management logic 824 can be configured to perform various operations such as, but not limited to, generating a wireless environment report request including at least one of a condition, a P2P technology specification, a non-IEEE 802.11 technology specification, or an element restriction, transmitting the generated wireless environment report request, and receiving a wireless environment report based on the transmitted wireless environment report request. In yet various embodiments, the network management logic 824 may also be responsible for augmented P2P wireless environment reporting. In yet more embodiments, the network management logic 824 can be further configured to perform various operations such as, but not limited to, generating a wireless environment report request, transmitting the generated wireless environment report request to a peer client device via a P2P link, and receiving a wireless environment report based on the transmitted wireless environment report request from the peer client device via the P2P link. In additional embodiments, the network management logic 824 can be configured to perform various operations such as, but not limited to, receiving a wireless environment report request including at least one of a condition, a P2P technology specification, a non-IEEE 802.11 technology specification, or an element restriction, generating a wireless environment report based on the received wireless environment report request, and transmitting the wireless environment report to another device, for example, an access point, a WLC, a peer client device, etc.

In still yet more embodiments, the storage 818 can include report request data 828. The report request data 828 may relate to data representative of the wireless environment report request generated or received by the device 800. For example, the report request data 828 may include information on the conditions, technology specifications, information elements, SSIDs, channels or bands, or the like, based on which the wireless environment report may be generated.

In many further embodiments, the storage 818 can include report data 830. The report data 830 may relate to data representative of the wireless environment report generated or received by the device 800. The report data 830 can include, but is not limited to, SSIDs on indicated channels or bands, BSSIDs, RSSIs, results of criteria-based evaluations including one or more logical operations, P2P communication data, channel information, maximum/minimum information, or the like.

In many additional embodiments, the storage 818 can include wireless environment data 832. The wireless environment data 832 may relate to data from an RF view of a STA that can help extend the access point view to the ground, and provide information that may be useful to the network infrastructure. For example, the wireless environment data 832 may include P2P communication data, VLP system information, active non-Wi-Fi radio data, RSSI and SNR data on various channels or bands, channel utilization data, roaming data, or the like.

Finally, in still yet further embodiments, data may be processed into a format usable by a machine-learning (“ML”) model 826 (e.g., feature vectors), and or other pre-processing techniques. The ML model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models. The ML model 826 may be configured to analyze the report request data 828, the report data 830, and the wireless environment data 832 to perform augmented wireless environment reporting for optimizing wireless network management. In various embodiments, the ML model 826 may be utilized to identify various parameters to include in the wireless environment report request. For example, the ML model 826 may analyze the wireless environment data 832 and identify parameters that are required to augment the wireless environment data 832. Once the parameters are identified, the network management logic 824 may utilize the parameters (e.g., at least one of a condition, a P2P technology specification, a non-IEEE 802.11 technology specification, or an element restriction) generate wireless environment report requests.

Although a specific embodiment for a device 800 suitable for configuration with the network management logic 824 for carrying out the various steps, processes, methods, and operations described herein is discussed with respect to FIG. 8, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the network management logic 824 acts in tandem between the devices. The elements depicted in FIG. 8 may also be interchangeable with other elements of FIGS. 1-7 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a processor;
a network interface controller configured to provide access to a network; and
a memory communicatively coupled to the processor, wherein the memory comprises a network management logic that is configured to:
generate a wireless environment report request, wherein the wireless environment report request comprises at least one of a condition, a Peer-to-Peer (P2P) technology specification, a non-IEEE 802.11 technology specification, or an element restriction;
transmit the generated wireless environment report request; and
receive a wireless environment report based on the transmitted wireless environment report request.

2. The network device of claim 1, wherein the wireless environment report request comprises the condition.

3. The network device of claim 2, wherein the wireless environment report request is configured to indicate an excluded service set identifier (SSID).

4. The network device of claim 2, wherein the wireless environment report request is configured to indicate a service set identifier (SSID) and the condition associated with the SSID.

5. The network device of claim 2, wherein the wireless environment report request is configured to indicate at least one of a channel or a band.

6. The network device of claim 5, wherein the wireless environment report request is further configured to indicate reporting of a local service set identifier (SSID) on the indicated at least one of the channel or the band.

7. The network device of claim 5, wherein the wireless environment report request is further configured to indicate reporting of an absence of a neighbor service set identifier (SSID) on the indicated at least one of the channel or the band.

8. The network device of claim 5, wherein the wireless environment report request is further configured to indicate reporting of all local service set identifiers (SSIDs) on the indicated at least one of the channel or the band based on a local SSID being detected on the indicated at least one of the channel or the band.

9. The network device of claim 5, wherein the wireless environment report request is further configured to indicate reporting of all local service set identifiers (SSIDs) on the indicated at least one of the channel or the band based on a local SSID being undetected on the indicated at least one of the channel or the band.

10. The network device of claim 2, wherein the wireless environment report request is further configured to indicate reporting of a result of a criteria-based evaluation.

11. The network device of claim 10, wherein the criteria-based evaluation comprises one or more logical operations.

12. The network device of claim 1, wherein the wireless environment report request comprises the P2P technology specification.

13. The network device of claim 12, wherein the wireless environment report request is configured to indicate reporting of a number of P2P pairs.

14. The network device of claim 1, wherein the wireless environment report request comprises the non-IEEE 802.11 technology specification.

15. The network device of claim 14, wherein the wireless environment report request is configured to indicate at least one of a channel or a band.

16. The network device of claim 1, wherein the wireless environment report request comprises the element restriction.

17. The network device of claim 1, wherein the wireless environment report request is transmitted to a client device, and the wireless environment report is received from the client device.

18. A client device, comprising:
a processor;
a network interface controller configured to provide access to a network; and
a memory communicatively coupled to the processor, wherein the memory comprises a network management logic that is configured to:
generate a wireless environment report, wherein the wireless environment report is associated with at least one of a condition, a Peer-to-Peer (P2P) technology specification, a non-IEEE 802.11 technology specification, or an element restriction; and
transmit the wireless environment report.

19. The client device of claim 18, wherein the network management logic is further configured to receive a wireless environment report request, the wireless environment report request comprising the at least one of the condition, the P2P technology specification, the non-IEEE 802.11 technology specification, or the element restriction, and wherein the wireless environment report is generated based on the received wireless environment report request.

20. A client device, comprising:
a processor;
a network interface controller configured to provide access to a network; and
a memory communicatively coupled to the processor, wherein the memory comprises a network management logic that is configured to:
generate a wireless environment report request;
transmit the generated wireless environment report request to another client device via a Peer-to-Peer (P2P) link; and
receive a wireless environment report based on the transmitted wireless environment report request from the another client device via the P2P link.
